(19) United States
(12) Patent Application Publication
(10) Pub. No.: US 2019/0247942 A1
(43) Pub. Date: Aug. 15, 2019

(54) METHOD FOR PRODUCING A PLATE HEAT EXCHANGER BLOCK WITH TARGETED APPLICATION OF THE SOLDER MATERIAL TO FINS AND SIDEBARS IN PARTICULAR

(71) Applicant: Linde Aktiengesellschaft, Munich (DE)

(72) Inventors: Herbert AIGNER, Engelsberg (DE); Gunther MATHE, Emmerting (DE)

(73) Assignee: Linde Aktiengesellschaft, Munich (DE)

(21) Appl. No.: 16/329,273

(22) PCT Filed: Aug. 31, 2017
(86) PCT No.: PCT/EP2017/025247

§ 371 Date: Feb. 28, 2019

(30) Foreign Application Priority Data
Sep. 1, 2016 (EP) 16001912.1

(51) Int. Cl. B23K 1/00

(52) U.S. Cl. CPC B23K 1/0012; B23K 1/008

(57) ABSTRACT

The present invention relates to a method for producing a soldered plate heat exchanger block. The plate heat exchanger block is made up of separating plates, sidebars and heat conducting structures. The heat conducting structures have or form a corrugated structure with alternately arranged corrugation peaks and troughs and corrugation flanks. The corrugation peaks and troughs are arranged parallel to one another. The method comprises arranging the compounds in a stack by arranging the separating plates in parallel while inserting sidebars and heat conducting structures between the separating plates, and soldering the stack. Before arranging the components in a stack, solder material is applied to one or more of the components in such a way that a respective abutting area of the sidebars, a respective abutting area of the heat conducting structures and/or a respective abutting region of the separating plates is formed by solder, surface regions located on one side of a respective separating plate between the abutting regions and/or the abutting areas are free from a solder layer or are not in contact with a solder layer.

The invention relates to a method for producing a plate-type heat exchanger block.

Plate-type heat exchangers are known from the prior art, which are designed to transfer the heat of a first fluid indirectly to another, second fluid. Here, the fluids are guided in the plate-type heat exchanger in separate heat exchange passages of the plate-type heat exchanger block. Said passages are delimited by in each case two parallel separating plates of the plate-type heat exchanger block, between which in each case a heat-conducting structure is arranged, the latter also being referred to as a fin.

Such plate-type heat exchanger blocks are shown and described for example in “The standards of the brazed aluminium plate-fin heat exchanger manufacturers' association” ALPEMA, third edition, 2010. Such a plate-type heat exchanger block has multiple separating plates in the form of separating sheets, which are arranged parallel to one another and form a multiplicity of heat exchange passages for the fluids to be brought into indirect heat exchange with one another. The heat exchange between the fluids involved in the heat exchange takes place here between adjacent heat exchange passages, wherein the heat exchange passages and thus the fluids are separated from one another by the separating plates. The heat exchange is realized by means of heat exchange via the separating plates and the heat-conducting structures (fins) arranged between the separating plates. The heat exchange passages are closed off toward the outside by edge strips (for example in the form of sheet strips), which are also referred to as side bars, fitted to the edge of the separating sheets in a flush manner. The plate-type heat exchanger block is furthermore delimited toward the outside by two outermost separating plates, which form cover plates (for example in the form of cover sheets). The two cover plates are therefore each formed by an outermost separating plate of the plate-type heat exchanger block.

For supplying and discharging the heat-exchanging fluids, collectors with connecting pieces, which serve for the connection of supplying and discharging pipelines, are fitted to the heat exchanger block over inlet and outlet openings of the heat exchange passages.

Such plate-type heat exchangers are preferably formed from aluminum, wherein the components are connected to one another by way of brazing.

The production of such a soldered plate-type heat exchanger is described for example in the article “The Manufacture of Plate-Fin Heat Exchangers at Linde” by Dr. Wolfgang Diery in the Linde Reports on Science and Technology from 1984, no. 37.

Accordingly, firstly the components such as separating plates, fins and side strips are provided in the corresponding dimensions. Following a subsequent washing process, said components are arranged in a stack, wherein the separating plates are arranged parallel to one another with interposition of fins and in each case at least two side bars.

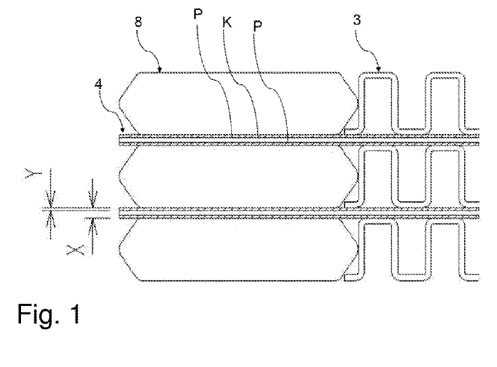

The separating plates (with the exception of the cover plates) are, as can be seen from FIG. 1 of the present patent application, each provided on both sides with a solder layer P which has been applied to a core material K. FIG. 1 also shows the separating sheets 4, stacked one above the other with interposition of the fins 3 and side bars 8, with solder cladding P according to the specified prior art.

According to FIG. 1, such separating sheets are generally produced in that, firstly, a stack of three bars comprising the cladding material P, the core material K and a further cladding material P is put together.

The three bars P, K, P are then tacked to one another at the edges in a punctiform manner by way of welded connections and, in a subsequent cladding rolling process, connected to one another in an areal manner and rolled to the required thickness. Generally, the ratio Y/X of the solder cladding thickness Y to the total thickness X lies between 10% and 18%.

A disadvantage of this method is that, unlike the simplified illustration in FIG. 1, the thickness Y of the cladding material P generally varies over the surface of the core material K, specifically in such a way that very thin cladding regions can be present sporadically, these being worn down further during the subsequent washing process. It is proposed in U.S. Pat. No. 4,053,969 (FIG. 1, 2) to spray a mixture of solder powder and binding agent onto the corrugated sheets and the side strips and subsequently to remove said mixture from the surfaces, such as for example the surfaces 1a, such that the solder is present only on the surfaces of the depressions, that is to say the lateral surfaces 1b and the bases 1c of the channels of the corrugated sheets, and on the lateral surfaces 3b of the side strips.

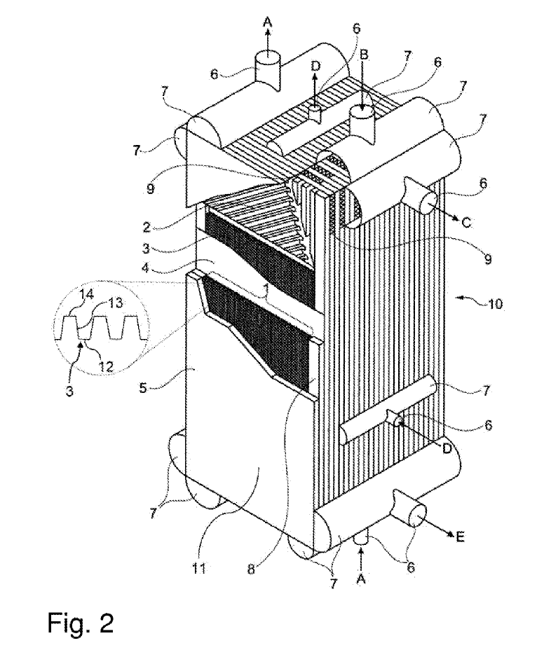

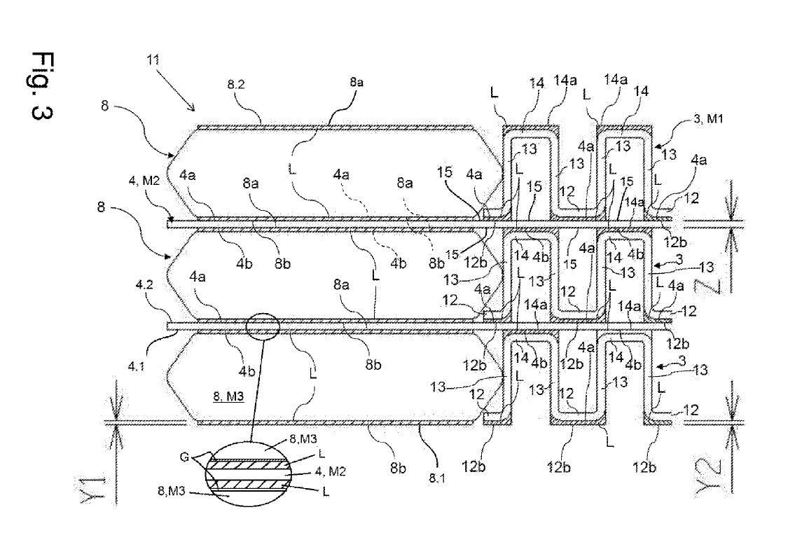

WO 2015/067356A1 refers to a method for indirect heat exchange between a salt melt and a heat carrier in a plate-type heat exchanger. This is produced in that the individual passages 3 with fins 30 (FIG. 3), separating sheets 4 and side bars 8 (FIG. 2) are stacked one on top of the other, provided with solder and brazed in a furnace.

US 2006/0090820 shows, in FIG. 2, a soldered plate-type heat exchanger. This is produced in that a required number of preforms is prepared, each of which is formed from a sheet of solder material. A preform is in each case placed between adjacent fins 2 and plates 1, which are to be connected to one another by soldering. Following the soldering, the contact region between the adjacent plates 1 and fins 2 is provided almost completely with solder material 4.

Taking this as a starting point, it is the object of the present invention to provide an improved method for producing a plate-type heat exchanger block.

This object is achieved by a method having the features of claim 1. Advantageous configurations of the method according to the invention are specified in the corresponding dependent claims and will be described below.

Provided accordingly is a method for producing a soldered plate-type heat exchanger block which has a plurality of heat exchange passages for the indirect heat exchange between at least two fluids, wherein the plate-type heat exchanger block is constructed from separating plates, edge strips and heat-conducting structures as components, wherein the heat-conducting structures have or form a wave-shaped structure with alternately arranged wave crests and wave flanks, and wherein the wave crests are arranged parallel to one another, wherein the method according to the invention comprises the following steps:
arrangement of the components in a stack through parallel arrangement of the separating plates, with insertion of edge strips and heat-conducting structures between the separating plates, wherein a respective heat exchange passage is delimited by in each case at least two edge strips, and wherein the edge strips each bear with a first bearing surface against a bearing region of an adjacent separating plate and with a further, second bearing surface, facing away from the first bearing surface, against a further bearing region of a further adjacent separating plate, and wherein the wave crests of the respective heat-conducting structure(s) each bear with a bearing surface against an associated bearing region of the adjacent separating plates, and
soldering of the stack.

According to the invention, prior to the arrangement of the components in the stack, solder material is applied in such a way to one or more of the components of the plate-type heat exchanger block
that the respective bearing surface and/or the respective bearing region are/is formed from solder, and
that, when viewed following the arrangement of the components in the stack and prior to the soldering of the stack, surface regions which are situated on one side of a respective separating plate between the bearing regions and/or the bearing surfaces are free of a solder layer or are not in contact with a solder layer.

Through the targeted application of solder material layers at desired connection regions between the components of the plate-type heat exchanger block, the present invention makes possible a reduction in the solder material in comparison with the prior art mentioned in the introduction, in the case of which the separating plates are provided on both sides with a solder layer over the full surface area. The targeted application of the solder at the connection points is advantageous since, specifically in the case of small heights of fins with narrow separation, the formed flow ducts are not constricted by excess solder in the cross section, which could otherwise lead to unpredictable influences on pressure losses and heat transfers.

Preferably, the solder is applied to one or more of the components prior to the arrangement of the components in the stack in such a way that, when viewed following the arrangement of the components in the stack and prior to the soldering of the stack, all the surface regions which are situated on one side of a respective separating plate between the bearing regions and/or the bearing surfaces are free of a solder layer or are not in contact with a solder layer.

In particular, therefore, according to one embodiment of the invention, the individual bearing surfaces are separated from one another and, prior to the production of the solder connection, have no connection, consisting of the solder material, to one another. The same also applies in particular to the bearing regions if these are each formed by a solder material layer. That is to say, in particular the bearing regions on the same side of a separating plate are, at least prior to the soldering of the components, separated from one another by regions which have no solder material.

According to a preferred embodiment, prior to the arrangement of the components in the stack, the solder material is applied to the edge strips and the heat-conducting structures and the separating plates remain free of a solder layer. Accordingly, according to the invention, it is for example possible for solder material to be applied merely to the side bars and/or fins in a defined manner, with the result that these acquire delimited bearing surfaces which are separated from one another and which are each formed by a delimited solder material layer, wherein, in this case, the separating plates do not acquire any solder material.

It is furthermore also possible for the respective solder material to be applied to the separating plates prior to the arrangement of the components in the stack, and for the edge strips and the heat-conducting structures to be left free of a solder layer, that is to say not to be provided with a solder layer. This means that the solder layer is not applied to the side bars or the fins but to the separating plates, with the result that these separating plates each have a plurality of bearing regions which are separated from one another and which are each formed by a delimited solder material layer.

According to the invention, these two basic procedures may of course also be combined with one another in any desired manner, with the result that it is basically possible for the respective bearing surface (side bar or fin) and/or the associated bearing region (separating plate), which contacts the bearing surface following the arrangement as intended of the separating plates (and of the further components of the plate-type heat exchanger block), to be formed by in each case one solder material layer. For example, it possible for the solder material to be applied to the separating plates, the edge strips and the heat-conducting structures prior to the arrangement of the components in the stack.

The present invention also advantageously allows not only targeted application of solder at the required points but also the provision of different solder quantities in dependence on the respective requirement.

Thus, in the method of the prior art, for example, in the region of the side bars, a leakage is accepted in specific applications in order to ensure a secure connection in the region of the fins. With solder material applied to the side bar, the layer thickness can be influenced in a targeted manner and thus the risk of leakage reduced.

According to a preferred embodiment of the method according to the invention, it is provided that, prior to the arrangement of the components in the stack, solder material is applied in such a way to the components of the plate-type heat exchanger block that the solder material of at least one bearing surface (that is to say the corresponding solder material layer) and/or the solder material of at least one bearing region (that is to say the corresponding solder material layer) has a thickness which differs from the thickness of the solder material of another bearing surface and/or of another bearing region. In this case, the direction of the respective thickness extends normal to the separating plates arranged one next to the other or one above the other. For example, the solder material layer between a side bar and a separating plate may be of thicker form than that between a fin and a separating plate.

Furthermore, the present invention also allows a modification to the composition of the solder material or a modification to the composition in dependence on the components to be connected, this significantly simplifying and speeding up the development process.

Therefore, according to a preferred embodiment of the method according to the invention, it is provided that, prior to the arrangement of the components in the stack, solder material is applied in such a way to components of the plate-type heat exchanger block that the solder material of at least one bearing surface and/or of at least one bearing region has a composition which differs from the composition of the solder material of another bearing surface and/or of another bearing region.

Preferably, after being applied, the solder material layer applied to the at least one component is a metal layer in the solid state of aggregation, which preferably contains no non-metallic constituents, in particular no fluxes, pastes or adhesives or the like.

According to a preferred embodiment of the present invention, prior to the arrangement of the components in the stack, the solder material is applied in such a way to one or more of the components of the plate-type heat exchanger block that, in at least one boundary layer between the respective component and the solder material, an alloy is formed between the solder material and the material of the respective component. In this way, a metallurgical or materially bonded, in other words also intermetallic, connection between the respective material of the component and the solder is produced. The solder layer is consequently insensitive to damage or detachments. In order to be able to form in a boundary layer between the respective component and the solder an alloy between the solder material and the material of the respective component, the solder material and the material of the respective component must be made to melt, and thus to fuse, in said boundary layer by, for example, introducing pressure and/or temperature.

According to a preferred embodiment of the method according to the invention, it is provided that the solder material for forming the bearing surfaces and/or bearing regions is printed onto the relevant components (for example side bars, fins, separating plates) by way of a 3D printing method, specifically in particular prior to the components of the plate-type heat exchanger block being arranged/stacked one next to the other or one above the other. In this way, it is possible to produce a solder layer of defined and, over its entire surface, constant thickness. Moreover, it is possible for the solder layer thickness to be of relatively small dimensions in comparison with the method mentioned in the introduction of the roll-cladding of the solder. In this case, ratios Y/X of the solder cladding thickness Y to the total thickness X, for example in the case of a separating plate, of less than 10%, for example 5% to 7%, can be achieved.

Preferably, the bearing surfaces and/or the bearing regions, which are formed on the components from solder (L), are formed with a thickness which is constant over the respective bearing surface and/or the respective bearing region.

Furthermore, according to a preferred embodiment of the method according to the invention, it is provided that, prior to the arrangement of the components in the stack, the bearing surfaces formed by solder material and/or the bearing regions formed by solder material are each formed such that the corresponding matching part comes into bearing contact in each case over the entire surface of the respective solder layer when the components are stacked.

Suitable 3D printing methods are known from the prior art. Preferably, in the method according to the invention, use is made of 3D printing methods in which the solder material or starting material is initially present in powder form or wire form. As a 3D printing method, it is possible in this respect to use for example electron beam melting, wherein the starting material (in powder or wire form) is melted in a targeted manner and, in this case, the 3D structure, or solder material layer, to be produced is produced layer by layer. Alternatively, use may also be made for example of laser sintering. In this case, the workpiece or the solder material layer is produced layer by layer from a starting material of powder form, wherein the melting of the powder particles is realized by means of laser light.

Alternatively or additionally, according to one embodiment, the solder material may be applied to said components by thermal spraying of the solder material (see also above). During the thermal spraying, the solder material is melted and is accelerated in a gas stream in the form of spray particles and thrown onto the surface of the component to be coated, with the result that this acquires one or more delimited bearing surfaces (side bars or fins) or one or more delimited bearing regions (separating plates).

bringing of the solder layer

According to an embodiment of the method according to the invention, it is provided that the separating plates, edge strips and heat-conducting structures are heated for example in a vacuum soldering furnace or a heat carrier bath such that the solder material is melted and solder connections are formed between the edge strips and the in each case adjacent separating plates and between the heat-conducting structures and the in each case adjacent separating plates. With the heating, the temperature is preferably set such that brazing of the components of the plate-type heat exchanger block takes place.

With the arrangement of the separating plates (with interposition of the side bars and fins), the separating plates are preferably arranged in a stack one above the other, with interposition of the side bars and the fins, such that they the separating plates each extend in a horizontal plane.

Furthermore, according to a preferred embodiment of the method according to the invention, it is provided that, prior to the arrangement of the components in the stack, the solder material is applied in such a way to the edge strips and heat-conducting structures that a metallurgical connection between the edge strips and the solder material and between the heat-conducting structures and the solder material is produced and merely the bearing surfaces of the edge strips and of the heat-conducting structures have solder material, wherein, in particular, the separating plates, in particular the bearing regions thereof, have no solder material prior to said formation of the solder connections. That is to say that, in this embodiment, the separating plates therefore have no solder material at all prior to the soldering of the individual components.

According to a preferred embodiment of the method according to the invention, the solder material contains at least one or more of the following substances: aluminum, silicon, magnesium.

By way of the method according to the invention, it is in particular possible to produce aluminum plate-type heat exchangers, in which said components may consist for example of a 3003 aluminum alloy. Further materials for the components are listed in tables 6-1 and 6-2 of the Alpema standard mentioned in the introduction. As a solder material, use may be made for example of a 4004 aluminum alloy.

In principle, the method according to the invention is however also conceivable for plate-type heat exchangers composed of high-grade steel.

Following the production of the plate-type heat exchanger block, collectors (also referred to as headers) may be welded to the plate-type heat exchanger block. It is possible via such a collector for a fluid to be introduced into associated heat exchange passages of the plate-type heat exchanger block or drawn out of said passages. A connecting piece is preferably welded to the respective collector, via which connecting piece the respective fluid can be introduced into the collector or drawn out of the latter.

The plate-type heat exchanger produced in such a way preferably has, per fluid, which is conducted into the plate-type heat exchanger, two collectors with connecting pieces, wherein the fluid is able to be introduced into the associated heat exchange passages via the one connecting piece and collector and is able to be discharged again via the other collector or connecting piece.

Preferably, a plate-type heat exchanger block produced by way of the method according to the invention has first heat exchange passages for a first fluid, which passages are each delimited by two adjacent separating plates and are each fluidically connected to two collectors for introducing or drawing out the first fluid, which, for example, are welded to the plate-type heat exchanger block. Furthermore, the plate-type heat exchanger preferably has second heat exchange passages for a second fluid, which passages are each delimited by two adjacent separating plates and are each fluidically connected to two further collectors for introducing or drawing out the second fluid, which, for example, are welded to the plate-type heat exchanger block.

The first and second heat exchange passages are preferably arranged one next to the other in an alternating manner, with the result that the two fluids flow through adjacent heat exchange passages and can exchange heat with one another indirectly. In the heat exchange passages, that is to say between in each case two adjacent separating walls, there is preferably arranged in each case one fin, which in particular has a corrugated structure with alternately arranged troughs and peaks, which are connected to one another by flanks of the respective structure such that each heat exchange passage forms a multiplicity of parallel ducts between the two in each case associated separating walls, through which ducts the respective fluid is able to flow.

Further features and advantages of the present invention will be described in the following descriptions of figures of exemplary embodiments of the invention on the basis of the figures, in which:

FIG. 1 shows a sectional view of a plate-type heat exchanger during production heat exchanger have a solder cladding over the full surface area on both sides;

FIG. 2 shows a perspective illustration of a plate-type heat exchanger produced by way of the method according to the invention;

FIG. 3 shows a first embodiment in a stacked view of the components, in which the solder material has been applied to the side bars and fins;

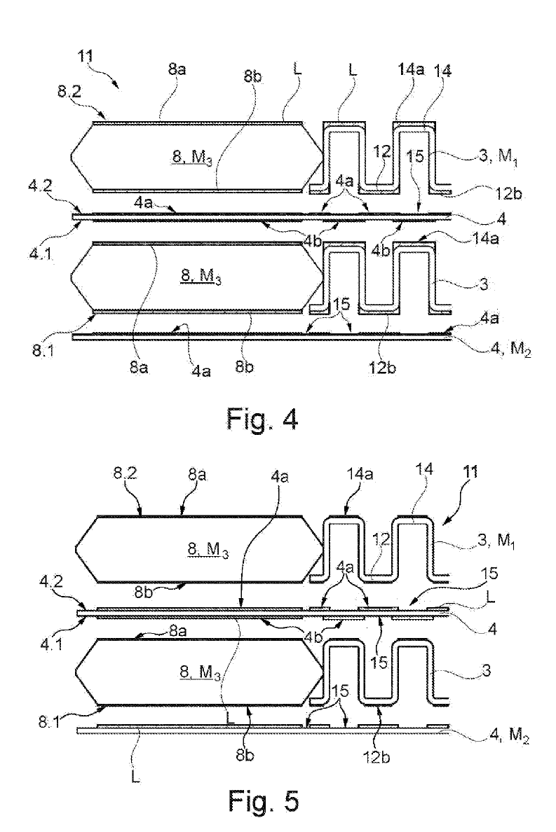

FIG. 4 shows the first embodiment in an exploded view;

FIG. 5 shows a second embodiment in an exploded view of a stack of the components, in which solder has been applied to the separating plates; and

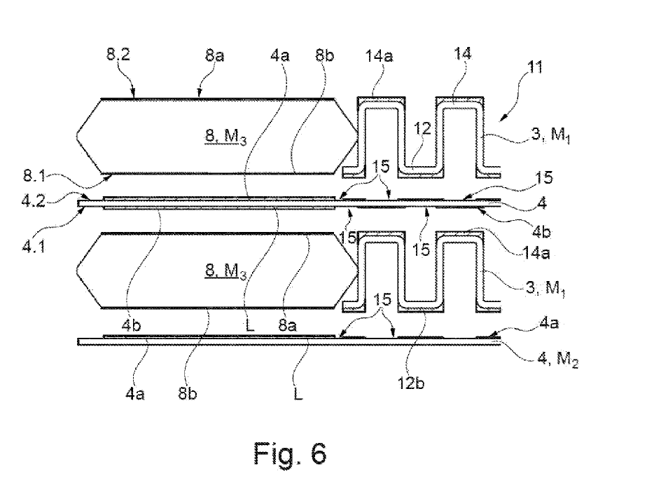

FIG. 6 shows a third embodiment in an exploded view of a stack of the components, in which, in connection regions between side bars and separating plates, solder has been applied only to the separating plates and, in connection regions between fins and separating plates, solder has been applied only to the fins.

FIG. 2 shows by way of example a plate-type heat exchanger 10, as is able to be produced by way of the method according to the invention. The plate-type heat exchanger 10 has multiple separating plates (for example in the form of separating sheets) 4, which are arranged parallel to one another and form a multiplicity of heat exchange passages 1 for the fluids A, B, C, D, E to be brought into indirect heat exchange with one another.

The separating plates 4 consist for example of an aluminum alloy. The heat exchange between the fluids A, B, C, D, E involved in the heat exchange takes place here between adjacent heat exchange passages 1, wherein the heat exchange passages 1 and thus the fluids are separated from one another by the separating plates 4. The heat exchange is realized by means of heat exchange via the separating plates 4 and via the heating surface elements (fins) 3 which are arranged between the separating plates 4 and may in particular likewise consist of an aluminum alloy.

The heat exchange passages 1 are closed off toward the outside by side strips in the form of metal bars 8, also referred to below as side bars 8, fitted to the edge of the separating plates 4 in a flush manner. Said side bars 8 may likewise consist of an aluminum alloy. The corrugated fins 3 are arranged within the heat exchange passages 1, or between in each case two separating plates 4, wherein a cross section of a fin 3 is shown in the detail in FIG. 2.

According thereto, the fins 3 each have a wave-shaped structure with alternating wave crests 12, 14 and wave flanks 13, wherein a lower wave crest 12 is connected in each case to an adjacent upper wave crest 14 via a wave flank 13 of the relevant fin 3, resulting in said wave-shaped structure.

The wave-shaped structure may have pronounced bent portions (bending edges) at the wave crests 12, 14, as illustrated in FIG. 3, or else have a trapezoidal shape, as illustrated in FIG. 2. It is also conceivable for the wave-shaped wave crests 12, 14 to run at right angles to the wave flanks 13.

As a result of the wave-shaped structure, channels for guiding a respective fluid A, B, C, D, E in the respective heat exchange passage 1 are formed—together with the separating plates 4 on both sides. The wave crests 12, 14 of the wave-shaped structure of the respective fin 3 are connected to the in each case adjacent separating plates 4 via solder connections, as will be explained further below. The fluids A, B, C, D, E involved in the heat exchange are thus in direct thermal contact with the wave-shaped structures 3, with the result that the heat transfer is ensured by the thermal contact between the wave crests 12, 14 and the separating plates 4. In order to optimize the heat exchange, the orientation of the wave-shaped structure is selected in dependence on the application so as to allow concurrent flow, cross flow, counter flow or cross-counter flow between adjacent passages.

The plate-type heat exchanger 10 also has openings 9 to the heat exchange passages 1, for example at the ends of the plate-type heat exchanger 10 or at a central section, via which openings it is possible for fluids A, B, C, D, E to be introduced into the heat exchange passages 1 or drawn out of the latter. In the region of said openings 9, it is possible for the individual heat exchange passages 1 to have distributor fins 2 which distribute the respective fluid to the channels of a fin 3 of the relevant heat exchange passage 1. A fluid A, B, C, D, E can therefore be introduced via an opening 9 of the plate-type heat exchanger block 11 into the associated heat exchange passage 1 and drawn back out of the relevant heat exchange passage 1 through a further opening 9.

The separating plates 4, fins 3 and side bars 8 and possibly further components (for example distributor fins 2) are connected to one another by soldering, preferably brazing, this being described below.

FIG. 3 shows, in a sectional view, a stack of separating plates 4, fins 3 and side bars 8 prior to the soldering of the stack 11 according to a first embodiment of the present invention. FIG. 4 likewise shows this first embodiment in an exploded view of a stack of components. In this first embodiment, prior to the arrangement of the components 3, 4 and 8 of the plate-type heat exchanger block 11 in the stack 11, solder layers L are applied in a defined manner to the fins 3 and the side bars 8, whereas no solder layer is applied to the separating plates 4. This means that the separating plates 4 have no solder layers L prior to the formation of the stack and thus prior to the soldering.

The application of the solder layers L is realized here in the following manner: Solder layers L are applied to the side bars 8 on both sides, that is to say in each case on the bottom side 8.1 thereof and on the top side 8.2 thereof, said solder layers thus forming an upper bearing surface 8a of solder L and a lower bearing surface 8b of solder L for the separating plates 4 to be placed in position.

Solder layers L are likewise applied to the fins 3 on the respective lower wave crests 12 and the respective upper wave crests 14, said solder layers then forming respective lower bearing surfaces 12b and upper bearing surfaces 14a of solder L for the separating plates 4 to be placed in position.

The individual bearing surfaces 8a, 8b or 14a, 12b are in this case formed by in each case one delimited solder material layer L. A detail of the solder material layers L applied to the side bars 8 is illustrated in the lower region in FIG. 3. The solder material layer L is produced for example by 3D printing or thermal spraying of the solder material L, with the result that the solder material L and the material M3 of the side bars 8 form an alloy with one another in a boundary layer G. The same applies to the solder L and the material M1 of the fins 3, this however not being illustrated in more detail. The alloy formation in the boundary layer G presupposes that both the solder material L and the material M3 of the side bars and the material M1 of the fins 3 are made to melt, and thus to fuse, in the boundary layer G through the effect of temperature and/or pressure.

According to FIG. 3, the solder material layers L of the side bars 8 have a thickness Y1 normal to the separating plates 4, while the fins 3 have a solder material layer L with a thickness Y2 normal to the separating plates 4. In FIG. 3, Z denotes the thickness of the separating plates 4. In this case, the thickness Y1 of the solder material layers L of the side bars 8 can differ from the thickness Y2 of the solder material layers L of the upper wave crests 14 and the lower wave crests 12 of the fins 3.

The solder layer thicknesses Y1 and Y2 may be selected in dependence on the respective application. Furthermore, the solder material L of different solder material layers L may have a different composition.

Following the application of the solder layers L, the solder-coated fins 3 and side bars 8 and the separating plates 4, which have no solder layer, in particular neither on their bottom side 4.1 nor on their top side 4.2, may be subjected to a washing process.

Subsequently, the components 3, 4 and 8 are arranged in the stack 11 shown in FIG. 3. The side bars 8 and the fins 3 (in particular also distributor fins, which are not shown in FIG. 3) are arranged in such a way that the side bars 8 each bear with an upper bearing surface 8a of solder L against a downwardly facing bearing region 4b on the bottom side 4.1 of a separating plate 4 which is adjacent toward the top, and bear with a downwardly facing bearing surface 8b of solder L, which faces away from the upper bearing surface 8a, against an upwardly facing bearing region 4a on the top side 4.2 of a separating plate 4 which is adjacent toward the bottom.

Furthermore, in the arrangement according to FIG. 3, the upper wave crests 14 of the respective fin 3 each bear with an upper bearing surface 14a of solder L against an associated downwardly facing bearing region 4b on the bottom side 4.1 of the separating plate 4 which is adjacent toward the top, whereas the lower wave crests 12 of the respective fin 3 each bear with a lower bearing surface 12b of solder L against an associated and upwardly facing bearing region 4a on the top side 4.2 of the separating plate 4 which is adjacent toward the bottom.

In this first exemplary embodiment according to FIGS. 3 and 4, the bearing regions 4a, 4b of the separating plates 4 have no solder material L, but rather are formed by the respective surface of the respective separating plate 4.

The solder material layers L, which preferably form planar bearing surfaces 8a, 8b or 14a, 12b with in each case constant thickness, which are intended for bearing against the associated bearing regions 4a or 4b of a separating plate 4 in a planar manner, are formed here separately from one another, or spaced apart from one another, and are each preferably situated merely in regions which are intended to form at a later stage (following the soldering) a solder connection between two components. In the stacked view of FIG. 3, solder-free regions 15 which have no contact with a solder layer L are thus situated between the bearing regions 4a, 4b of a separating plate side 4.1, 4.2.

In the first exemplary embodiment according to FIGS. 3 and 4, the solder material layers L are, as described above, applied merely to the side bars 8 and fins 3. In a departure from this embodiment, it is also possible of course for solder material layers L to be provided, according to a second embodiment, which is illustrated in FIG. 5, only on the separating plates 4. In this case, the bearing regions 4a and 4b on the separating plates 4 are formed from solder L, whereas the corresponding bearing surfaces 8a, 8b of the side bars 8 and bearing surfaces 12b and 14a of the fins 3 have no solder. The application of the solder layer L to the separating plates 4 is realized in such a way that the material M2 of the separating plates 4 forms an alloy with the solder L in a boundary layer, as illustrated in FIG. 3 in the detail for the side bars 8.

Furthermore, any desired combinations of the embodiments as per FIGS. 3, 4 and 5 are conceivable, in which a solder layer L is applied at least on one of the components 3, 4 and 8 in the planned connection region of the components 3, 4 and 8 or on both components.

It is for example, as illustrated in FIG. 6, furthermore possible for solder material layers L to be applied in the connection region between side bars 8 and the separating plates 4 to the adjacent separating plates 4, with the result that these have delimited bearing regions 4a and 4b of solder L against which in each case the associated side bar 8 then bears with its corresponding bearing surface 8a or 8b, the latter in each case then having no solder material L. This is also indicated in FIG. 3 on the basis of a separating plate 4 with broken lines to the corresponding reference signs 4a, 4b, 8a, 8b. By contrast, in the connection region between fins 3 and separating plates 4, solder material layers L are applied to the wave crests 12, 14 of the fins 3, with the result that these have delimited bearing surfaces 12b,14a of solder against which in each case an adjacent separating plate 4 then bears with its corresponding bearing regions 4a, 4b, the latter in each case having no solder material L.

It can be seen from FIGS. 3 to 6 that, when viewed following the stacking of the components 3, 4 and 8, with regard to a respective separating plate side 4.1 or 4.2, solder-free regions 15 which (at least prior to the soldering) have no solder material L are present between adjacent solder layers L.

This means that, for example in the first embodiment according to FIGS. 3 and 4, solder-free regions 15 are present in the horizontal direction between the upper bearing surfaces 8a, formed from solder, of the side bars and the bearing surfaces 14a, formed from solder, of the fins 3 with regard to a bottom side 4.1 of a separating plate 4. The same applies with regard to the top side of a respective separating plate 4.2: solder-free regions 15 are present in the horizontal direction between the lower bearing surfaces 8b of the side bars, which bearing surfaces are formed from solder L, and the bearing surfaces 12b, likewise formed from solder L, of the fins 3. This means, in other words, that, between the bearing regions 4a, 4b of the separating plates, with regard to a respective separating plate side 4.1, 4.2, regions 15 which are not in contact with a solder layer L, or else have no solder layer (L), following the stacking of the components 3, 4 and 8 are present.

If the components 8, 3, 4 are stacked such that (see FIG. 3) all the bearing surfaces 8a, 8b, 14a, 12b bear against the in each case associated bearing regions 4a, 4b, the components 8, 3, 4 arranged against one another are heated, preferably in a furnace or in a liquid heat carrier bath, such as for example of a salt melt, such that the solder material L is melted and, at the location of the bearing surfaces 8a, 8b, 14a, 12b, corresponding solder connections to the separating plates 4 are produced.

Following the soldering, for the purpose of supplying or discharging the heat-exchanging fluids A, B, C, D, E, it is possible for example for semi-cylindrical collectors 7 (or headers) to be welded on over the openings 9 (cf. FIG. 2).

Furthermore, preferably a cylindrical connecting piece 6 may be welded to each collector 7. The connecting pieces 6 serve for the connection of a supplying or discharging pipeline to the respective collector 7.

List of reference signs

| | |
|---|---|
| 1 | Heat exchange passage |
| 2 | Distributor fin |
| 3 | Fin, heat-conducting structure |
| 4 | Separating plate |
| 4.1 | Bottom side of separating plate |
| 4.2 | Top side of separating plate |
| 4a, 4b | Bearing region of separating plate |
| 5 | Cover plates |
| 6 | Connecting piece |
| 7 | Collector |
| 7a | Inner side |
| 7b | Edge |
| 8 | Side bar, edge strip |
| 8.1 | Bottom side of side bar |
| 8.2 | Top side of side bar |
| 8a, 8b | Bearing surface of side bar |
| 9 | Opening |
| 10 | Plate-type heat exchanger |
| 11 | Plate-type heat exchanger block, stack |
| 12 | Lower wave crest |
| 12b | Bearing surface of lower wave crest |
| 13 | Wave flank |
| 14 | Upper wave crest |
| 14a | Bearing surface of upper wave crest |
| 15 | Solder-free region |
| A, B, C, D, E | Fluid |
| G | Boundary layer |
| I | Inner space |
| L | Solder material or solder material layer |
| M1 | Material of heat-conducting structure 3 |
| M2 | Material of separating plate 4 |
| M3 | Material of side bar, edge strip 8 |
| Z | Thickness of separating plate |
| Y1 | Thickness of solder material layer of side |
| | bar |
| Y2 | Thickness of solder material layer of fin |

1. A method for producing a soldered plate-type heat exchanger block (11) which has a plurality of heat exchange passages (1) for the indirect heat exchange between at least two fluids, wherein the plate-type heat exchanger block (11) is constructed from separating plates (4), edge strips (8) and heat-conducting structures (3) as components (4, 8, 3), wherein the heat-conducting structures (3) have or form a wave-shaped structure with alternately arranged wave crests (12, 14) and wave flanks (13), and wherein the wave crests (12, 14) are arranged parallel to one another,
comprising the following steps:
arrangement of the components (3, 4, 8) in a stack (11) through parallel arrangement of the separating plates (4), with insertion of edge strips (8) and heat-conducting structures (3) between the separating plates (4), wherein a respective heat exchange passage (1) is delimited by in each case at least two edge strips (8), and wherein the edge strips (8) each bear with a first bearing surface (8a) against a bearing region (4b) of an adjacent separating plate (4) and with a further, second bearing surface (8b), facing away from the first bearing surface (8a), against a further bearing region (4a) of a further adjacent separating plate (4), and wherein the wave crests (12, 14) of the respective heat-conducting structure(s) (3) each bear with a bearing surface (12b, 14a) against an associated bearing region (4b) of the adjacent separating plates (4),
soldering of the stack (11),
characterized in that, prior to the arrangement of the components (3, 4, 8) in the stack, solder material (L) is applied in such a way to one or more of the components (3, 4, 8) of the plate-type heat exchanger block (11)
that the respective bearing surface (8a, 8b, 12b, 14a) and/or the respective bearing region (4a, 4b) are/is formed from solder, and
that, when viewed following the arrangement of the components (3, 4, 8) in the stack (11) and prior to the soldering of the stack (11), surface regions (15) which are situated on one side (4.1, 4.2) of a respective separating plate (4) between the bearing regions (4a, 4b) and/or the bearing surfaces (8a, 8b, 12b, 14a) are free of a solder layer (L) or are not in contact with a solder layer (L).

2. The method as claimed in claim 1, characterized in that, prior to the arrangement of the components (3, 4, 8) in a stack, solder material (L) is applied in such a way to one or more of the components (3, 4, 8) of the plate-type heat exchanger block (11) that, in at least one boundary layer (G) between the respective component (3, 4, 8) and the solder material (L), an alloy is formed between the solder material (L) and the material (M1, M2, M3) of the respective component (3, 4, 8).

3. The method as claimed in claim 1, characterized in that, when viewed following the arrangement of the components in the stack (11) and prior to the soldering of the stack (11), all the surface regions (15) which are situated on one side of a respective separating plate (4) between the bearing regions (4a, 4b) and/or the bearing surfaces (8a, 8b, 12b, 14a) are free of a solder layer (L) or are not in contact with a solder layer (L).

4. The method as claimed in claim 1, characterized in that the bearing surfaces (8a, 8b, 12b, 14a) and/or the bearing regions (4a, 4b), which are formed on the components (3, 4, 8) from solder (L), are formed with a thickness (Y1, Y2) which is constant over the respective bearing surface (8a, 8b, 12b, 14a) and/or the respective bearing region (4a, 4b).

5. The method as claimed in claim 1, characterized in that the solder material (L) is applied in such a way to the components (8, 3, 4) of the plate-type heat exchanger block (11) that the solder material (L) of at least one bearing surface (8a, 8b, 12b, 14a) and/or of at least one bearing region (4a, 4b) has a thickness (Y1) which differs from the thickness (Y2) of the solder material (L) of another bearing surface (8a, 8b, 12b, 14a) and/or of another bearing region (4a, 4b).

6. The method as claimed in claim 1, characterized in that the solder material (L) is applied in such a way to the components (8, 3, 4) of the plate-type heat exchanger block (11) that the solder material (L) of at least one bearing surface (8a, 8b, 12b, 14a) and/or of at least one bearing region (4a, 4b) has a composition which differs from the composition of the solder material of another bearing surface (8a, 8b, 12b, 14a) and/or of another bearing region (4a, 4b).

7. The method as claimed in claim 1, characterized in that, prior to the arrangement of the components (3, 4, 8) in a stack, the solder material (L) is applied to the edge strips (8) and the heat-conducting structures (3), and the separating plates (4) are free of a solder layer (L).

8. The method as claimed in claim 1, characterized in that, prior to the arrangement of the components (3, 4, 8) in the stack (11), the solder material (L) is applied to the separating plates (4), and the edge strips (8) and the heat-conducting structures (3) are free of a solder layer (L).

9. The method as claimed in claim 1, characterized in that, prior to the arrangement of the components (3, 4, 8) in the stack (11), the solder material (L) is applied to the separating plates (4), the edge strips (8) and the heat-conducting structures (3).

10. The method as claimed in claim 1, characterized in that the solder material (L) is applied by way of a 3D printing method.

11. The method as claimed in claim 1, characterized in that the solder material (L) is applied by thermal spraying of the solder material (L).

12. The method as claimed in claim 1, characterized in that the solder material (L) contains at least one or more of the following substances: aluminum, silicon, magnesium.

13. The method as claimed in claim 1, characterized in that, after being applied, the solder material layer (L) applied to the at least one component (3, 4, 8) is a metal layer in the solid state of aggregation.
